(19) United States
(12) Patent Application Publication
(10) Pub. No.: US 2008/0064399 A1
(43) Pub. Date: Mar. 13, 2008

(54) System and method of optimizing handoff in a mobile communication network

(76) Inventor: Jeou-Kai Lin, Campbell, CA (US)

Correspondence Address: FORTUNE LAW GROUP LLP, 100 CENTURY CENTER COURT, SUITE 315, SAN JOSE, CA, 95112, US

(21) Appl. No.: 11/518,300

(22) Filed: Sep. 9, 2006

(51) Int. Cl. H04Q 7/20

(52) U.S. Cl. 455/436

(57) ABSTRACT

A system and method of optimizing handoff in a mobile communication network is disclosed. The method includes the steps of (a) making a first determination of a direction of movement of a mobile station relative to each of a plurality of access points or base stations, (b) for each of the plurality of access points or base stations that the mobile station is moving toward, making a second determination of the signal quality of each of the plurality of access points or base stations, and (c) handing off to an access point or base station of choice based upon a best signal quality. A mobile station processor is operable to execute method steps stored as executable instructions in a mobile station storage device coupled to the mobile station processor.

### BACKGROUND OF THE INVENTION

The present invention generally relates to mobile communications and more particularly to a system and method of optimizing handoff in a mobile communication network.

In wireless communication systems, whether IP based (WiFi and WiMAX), or cellular based, mobility and continuity of service are ensured by handover or handoff procedures. A handoff procedure transfers control of a mobile device from a first access point or base station to a second access point or base station when the mobile device moves out of range of the first access point or base station. The handoff procedure may determine not only which of a plurality of second access points or base stations to transfer control to, but also the timing of such transfer.

U.S. Pat. No. 7,089,007 to Wakuta et al. discloses a method and apparatus for performing handoff by varying a threshold level which is set in a mobile station according to the quality of a wireless link between the mobile station and a first wireless base station that currently controls the mobile station. The quality of the wireless link includes an error rate and the received signal strength. However, it is known that the signal strength may vary even for a non-moving mobile station and therefore signal strength is not a reliable signal attribute to use in determining the direction of movement of the mobile station.

There is therefore a need in the art for a system and method of optimizing handoff in a mobile communications network that provides a more reliable signal attribute to determine the direction of movement of the mobile station. There is a further need for a system and method for optimizing handoff in a mobile communications network that provides for a more reliable determination of the quality of the wireless connection. There is a further need for a system and method of optimizing handoff in a mobile communications network that provides for a more reliable determination of handoff timing. There is also a need for a system and method of optimizing handoff in a mobile communications network that avoids redundant handoffs. There is a further need for a system and method of optimizing handoff in a mobile communications network that is able to manage a fast moving mobile station. There is also a need for a system and method of optimizing handoff in a mobile communications network that provides improved quality of service in infrastructure networks.

### SUMMARY OF THE INVENTION

In accordance with one aspect of the invention, a system and method of optimizing handoff in a mobile communication system comprises a first determination of a direction of movement of the mobile station relative to each of a plurality of access points or base stations and a second determination of a signal quality of a current connection and of potential handoff connections.

In accordance with one aspect of the invention, a method of optimizing handoff in a mobile communications network includes the steps of (a) making a first determination of a direction of movement of a mobile station relative to each of a plurality of access points or base stations, (b) for each of the plurality of access points or base stations that the mobile station is moving toward, making a second determination of the signal quality of each of the plurality of access points or base stations, and (c) handing off to an access point or base station of choice based upon a best signal quality.

In accordance with another aspect of the invention, a system of optimizing handoff in a mobile communications network comprises a mobile station processor, and a storage device coupled to the mobile station processor, the storage device comprising instructions operable to instruct the mobile station processor to make a first determination of a direction of movement of a mobile station relative to each of a plurality of access points or base stations, for each of the plurality of access points or base stations that the mobile station is moving toward, to make a second determination of the signal quality of each of the plurality of access points or base stations, and to hand off to an access point or base station of choice based upon a best signal quality.

In accordance with yet another aspect of the invention, a method of optimizing handoff in a mobile communications network includes the steps of (a) scanning each of a plurality of access points or base stations, (b) discovering and calculating a plurality of signal attributes for each of the plurality of access points or base stations, the signal attributes including data rates, (c) determining the sign of a difference between a current data rate and a prior data rate of a current connection, (d) if the sign of the difference between the current data rate and the prior data rate of a current connection is negative, searching the plurality of access points or base stations for access points or base stations having a positive or zero difference between the current data rate and the prior data rate of a potential connection, and determining a best signal quality from among the access points or base stations having the positive or zero difference between the current data rate and the prior data rate of a potential connection, (e) if the sign of the difference between the current data rate and the prior data rate of the current connection is positive or zero, determining the best signal quality from among the access points or base stations having the positive or zero difference between the current data rate and the prior data rate of the potential connection, and (f) handing off the connection to the potential access point or base station having the best signal quality.

There has been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended herein.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

These and other features, aspects and advantages of the present invention will become better understood with reference to the following drawings, description and claims.

### BRIEF DESCRIPTION OF THE DRAWINGS

FIG. 1 is a flow chart illustrating a method of optimizing handoff in a mobile communications network in accordance with the invention.

### DETAILED DESCRIPTION OF THE INVENTION

The present invention provides a system and method of optimizing handoff in a mobile communications network that provides a first determination of a direction of movement of the mobile station relative to each of a plurality of access points or base stations. The first determination is based upon a comparison of data rates received from each access point or base station in response to scanning signals sent by the mobile station. A difference between a current data rate and a prior data rate provides a measure of the direction of movement of the mobile station relative to each of a plurality of access points or base stations. A positive or zero difference indicates movement toward an access point or base station and a negative difference indicates movement away from the access point or base station.

A second determination of the quality of the current connection and of potential handoff connections is based upon a plurality of factors including a difference between a current response time and a prior response time, a difference between a current signal to noise ration and a prior signal to noise ratio, a difference between a current signal strength index and a prior signal strength index, and the current magnitudes of the signal to noise ration, the signal strength index and the response time. A signal level may alternatively be used in place of the signal strength index.

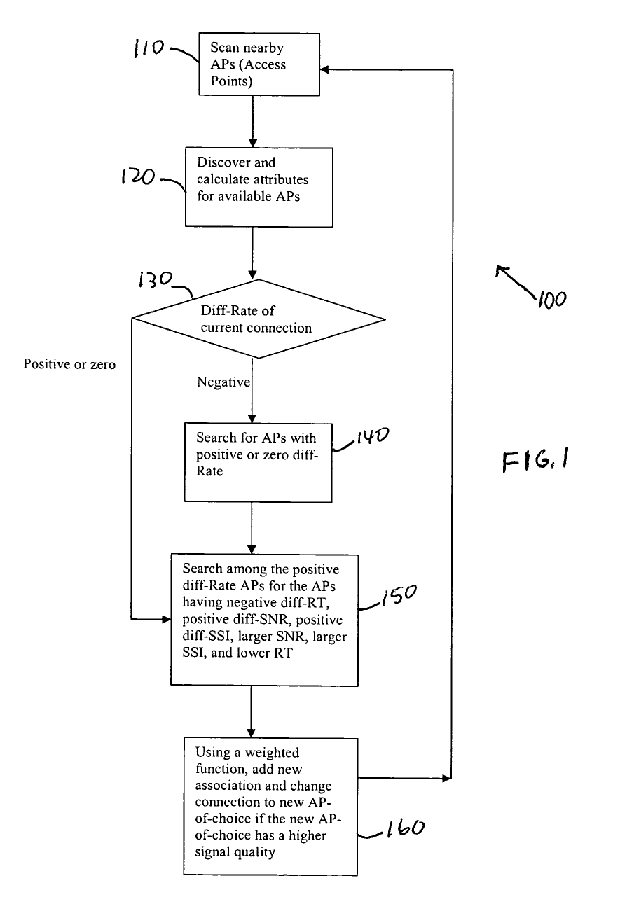

With reference to FIG. 1, a method of optimizing handoff in a mobile communication system generally designated 100 includes a step 110 in which a mobile station scans each of a plurality of access points or base stations, including the current access point or base station. In a step 120, signal attributes including a data rate, a response time, a signal to noise ratio and the signal strength index are discovered by the mobile station for each of the plurality of access points or base stations. Additionally, a difference between a current data rate and a prior data rate (diff-Rate), a difference between a current response time and a prior response time (diff-RT), a difference between a current signal to noise ratio and a prior signal to noise ratio (diff-SNR), and a difference between a current signal strength index and a prior signal strength index (diff-SSI) are calculated for each of the plurality of access points or base stations in the mobile station.

In a step 130, a determination as to the sign of the difference between a current data rate and a prior data rate (diff-Rate) of the current access point or base station is made. A positive or zero diff-Rate indicates that the mobile station is moving toward the current access point or base station. A negative diff-Rate indicates that the mobile station is moving away from the current access point or base station.

If the diff-Rate of the current access point or base station is negative (indicating that the mobile station is moving away from the current access point or base station), then in a step 140 access points or base stations having a zero or positive diff-Rate are searched. These access points or base stations represent potential handoff access points or base stations.

The method 100 then determines the signal quality of each of the access points or base stations having a zero or positive diff-Rate (including the current access point or base station if its diff-Rate is zero or positive). In a step 150, the access points or base stations having a zero or positive diff-Rate are searched to determine access points or base stations having negative diff-RTs, positive diff-SNRs, positive diff-SSIs, large SNRs, large SSIs, and low RTs. These attributes serve as indicators of the quality of the signal strength of each of the access points or base stations. More particularly, diff-RT and RT relate to the priority given to the connection by the access points or remote stations.

Finally, in a step 160, a weighted function having the values of the diff-RTs, diff-SNRs, diff-SSIs, SNRs, SSIs, and RTs as variables may be used to determine the signal quality for each access point or base station having a zero or positive diff-Rate. The weighted function may assign different weights to different variables as a matter of design choice. An access point or base station having a best signal quality as determined by use of the weighted function is designated as an access point or base station of choice. A new association may be created in the mobile station and the connection changed to the new access point or base station of choice to affect the handoff. Use of the weighted function may determine that handoff is not merited.

A system of optimizing handoff in a mobile communication system includes a mobile station processor operable to execute instructions to perform the steps of method 100. The instructions may be stored in a storage device or memory coupled to the mobile station processor as is well known in the art.

The system and method of optimizing handoff in a mobile communication system in accordance with the invention provides in the diff-Rate a more reliable signal attribute to determine the direction of movement of the mobile station relative to a plurality or access points or base stations. The system and method further provide for a more reliable determination of the quality of the signal quality of the wireless connection by employing a weighted function having as variables attributes of the signal quality.

It should be understood, of course, that the foregoing relates to preferred embodiments of the invention and that modifications may be made without departing from the spirit and scope of the invention as set forth in the following claims.

I claim:

1. A method of optimizing handoff in a mobile communication network comprising the steps of:
making a first determination of a direction of movement of a mobile station relative to each of a plurality of access points or base stations;
for each of the plurality of access points or base stations that the mobile station is moving toward, making a second determination of the signal quality of each of the plurality of access points or base stations; and
handing off to an access point or base station of choice based upon a best signal quality.

2. The method of claim 1, wherein the first determination comprises computing a difference between a current data rate and a prior data rate, a positive or zero difference indicating movement of the mobile station toward the access point or base station and a negative difference indicating movement away from the access point or base station.

3. The method of claim 1, wherein the second determination of the signal quality comprises computing the value of a weighted function.

4. The method of claim 3, wherein the weighted function comprises a variable including a difference between a current response time and a prior response time.

5. The method of claim 3, wherein the weighted function comprises a variable including a difference between a current signal to noise ratio and a prior signal to noise ratio.

6. The method of claim 3, wherein the weighted function comprises a variable including a difference between a current signal strength index and a prior signal strength index.

7. The method of claim 3, wherein the weighted function comprises a variable including a signal to noise ratio.

8. The method of claim 3, wherein the weighted function comprises a variable including a signal strength index.

9. The method of claim 3, wherein the weighted function comprises a variable including a response time.

10. A system of optimizing handoff in a mobile communication network comprising:
a mobile station processor; and
a storage device coupled to the mobile station processor, the storage device comprising instructions operable to instruct the mobile station processor to make a first determination of a direction of movement of a mobile station relative to each of a plurality of access points or base stations, for each of the plurality of access points or base stations that the mobile station is moving toward, to make a second determination of the signal quality of each of the plurality of access points or base stations, and to hand off to an access point or base station of choice based upon a best signal quality.

11. The system of claim 10, wherein the first determination comprises computing a difference between a current data rate and a prior data rate, a positive or zero difference indicating movement of the mobile station toward the access point or base station and a negative difference indicating movement away from the access point or base station.

12. The system of claim 10, wherein the second determination of the signal quality comprises computing the value of a weighted function.

13. A method of optimizing handoff in a mobile communication system comprising the steps of:
scanning each of a plurality of access points or base stations;
discovering and calculating a plurality of signal attributes for each of the plurality of access points or base stations, the signal attributes including data rates;
determining the sign of a difference between a current data rate and a prior data rate of a current connection;
if the sign of the difference between the current data rate and the prior data rate of a current connection is negative, searching the plurality of access points or base stations for access points or base stations having a positive or zero difference between the current data rate and the prior data rate of a potential connection, and determining a best signal quality from among the access points or base stations having the positive or zero difference between the current data rate and the prior data rate of a potential connection;
if the sign of the difference between the current data rate and the prior data rate of the current connection is positive or zero, determining the best signal quality from among the access points or base stations having the positive or zero difference between the current data rate and the prior data rate of the potential connection; and
handing off the connection to the potential access point or base station having the best signal quality.

14. The method of claim 13, wherein determining the best signal quality comprises computing the value of a weighted function.

15. The method of claim 14, wherein the weighted function comprises the discovered and computed signal attributes.

16. The method of claim 15, wherein the signal attributes comprise a response time.

17. The method of claim 15, wherein the signal attributes comprise a signal to noise ratio.

18. The method of claim 15, wherein the signal attributes comprise a signal strength index.

19. The method of claim 15, wherein the signal attributes comprise a difference between a current response time and a prior response time.

20. The method of claim 15, wherein the signal attributes comprise a difference between a current signal to noise ratio and a prior signal to noise ratio.
